(19) United States
(12) Patent Application Publication
(10) Pub. No.: US 2013/0009362 A1
(43) Pub. Date: Jan. 10, 2013

(54) Method and Apparatus for Playing Board Game

(76) Inventor: Peter Floodstrand Blanchard, Iowa City, IA (US)

(21) Appl. No.: 13/543,452

(22) Filed: Jul. 6, 2012

Related U.S. Application Data
(60) Provisional application No. 61/571,947, filed on Jul. 8, 2011.
(60) Provisional application No. 61/506,028, filed on Jul. 9, 2011.

(51) Int. Cl. A63F 3/00; A63F 13/00

(52) U.S. Cl. 273/267; 463/9

(57) ABSTRACT

A game of skill and strategy wherein at least two players alternate turns and place at least one game token in at least one open border slot surrounding one or more playing zones. Each player can then claim one or more zones by placing at least one game token within one or more of the zones when one of said players converts the last open border slot to a closed border slot, thereby completely surrounding said one or more of the zones. A winner is determined by evaluating the number of zones claimed by each player, and there are various ways to win.

### CROSS REFERENCE TO RELATED APPLICATIONS

This application claims the benefit of priority to U.S. Provisional Patent Application Ser. No. 61/571,947, filed on Jul. 8, 2011 and entitled “Method and apparatus for playing board game” and U.S. Provisional Patent Application Ser. No. 61/506,028, filed on Jul. 9, 2011 and entitled “Method and apparatus for playing board game,” the contents of each which are hereby incorporated herein by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Generally, the present embodiments relate to the field of games.

More particularly, the present disclosure relates to games, specifically to games that are simple to play such as well-known games like Tic-Tac-Toe, Dots and Boxes, while providing a more complex level of play. The game Tic-Tac-Toe, for example, also known as Naughts and Crosses, has been reported to have been played as long ago as 1300 B.C. Tic-Tac-Toe is known in many countries because it is extremely simple to learn and is played using an attractive and simple geometric layout. Tic-Tac-Toe is also flawed, however, because it quickly becomes repetitious and players including young children quickly learn to play the game to finish in a tie.

Prior art patents disclose some improvements to Tic-Tac-Toe. U.S. Pat. No. 5,318,307 to Bouchard, for example, describes a variation of Tic-Tac-Toe that involves the skilled tossing of markers to claim spaces on a board. U.S. Patent Application Publication No. 20070035087A1 to Guagliardo et. al. shows a game based on Tic-Tac-Toe that incorporates dice or other random generation methods to provide more randomized random play selection.

U.S. Pat. No. 3,879,040 to Smith discloses a 3-dimensional apparatus for playing a variation on the game Tic-Tac-Toe. Both U.S. Pat. No. 5,580,059 to Marks and U.S. Pat. No. 4,813,681 to Volpert, Jr. describe variations on the game Tic-Tac-Toe that employ cards to determine some aspects of play.

U.S. Pat. No. 3,747,926 to Odem describes a game in that points are awarded for playing certain pluralities of markers in configurations that include stacks and in-a-row, as in Tic-Tac-Toe.

### BRIEF SUMMARY

The present embodiments utilize familiar elements that allow the game to be simple to learn and play and never end in a tie. However, gameplay as disclosed is complex enough to be interesting and avoid repetitious play.

In one aspect, physical game boards are provided that are visually attractive and that also provide an enjoyable trajectory of play.

In another aspect, a method is provided wherein the embodiments of the disclosed game boards may be used in gameplay.

In yet another aspect of the invention, a method of playing a game between a plurality of players using a game board is disclosed. The game board includes a playing area divided into a plurality of zones by a plurality of border slots. Each of the slots is adapted to receive at least one game token therein, and the zones are sized to receive at least one game token therein. When playing the game, each player alternates his or her turn by placing at least one game token in at least one of the border slots. This placement converts an open border slot into a closed border slot. Each player can then claim one or more zones by placing at least one game token within one or more of the zones when one of said players converts the last open border slot to a closed border slot, thereby completely surrounding said one or more of the zones. A winner is determined by evaluating the number of zones claimed by each player, and there are various ways to win depending on the arrangement of claimed slots or zones or the number of claimed zones.

In again another aspect of the invention, a game playing apparatus for use in playing a game using a plurality of game tokens is disclosed. The apparatus includes at least one surface that may be marked with the game tokens, and a plurality of zones therein. A plurality of slots borders one or more zones, and the slots are configured to support at least one game token in a first orientation. Each of the zones is further configured to support at least one game token in at least a second orientation to surround the zone with game tokens.

### BRIEF DESCRIPTION OF THE DRAWINGS

FIG. 1 is a schematic illustration of a first embodiment of a game board in accordance with one aspect of the present invention;

FIG. 2 is a schematic illustration of the embodiment of FIG. 1 further illustrating the placement of game pieces;

FIG. 3 is a photograph of a view of an embodiment similar to that shown in FIGS. 1 and 2;

FIG. 4 is a schematic illustration of a second embodiment of a game board in accordance with another aspect of the present invention;

FIG. 5 is a schematic illustration of the embodiment of FIG. 4 further illustrating the placement of game pieces;

FIG. 6 is a photograph of a view of an embodiment similar to that shown in FIGS. 4 and 5; and

FIG. 7 is a flow diagram illustrating an embodiment of a playing method in accordance with another aspect of the present invention.

### DETAILED DESCRIPTION OF THE DRAWINGS AND THE PRESENTLY PREFERRED EMBODIMENTS

### Game Description

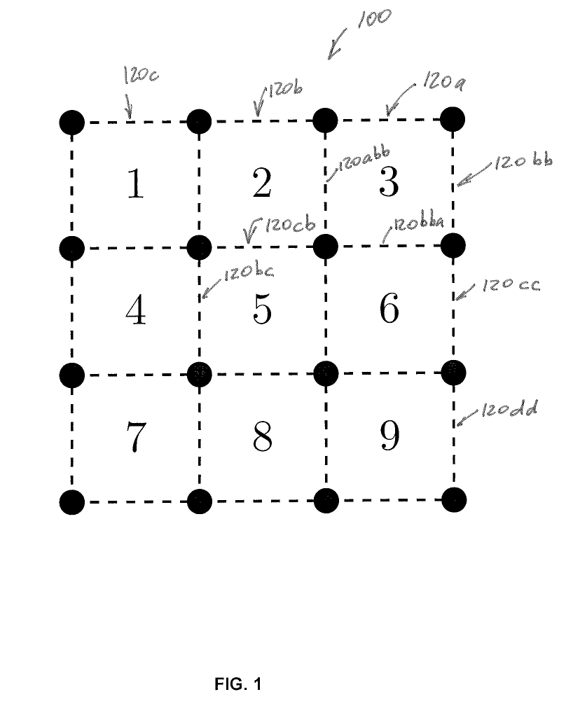

In general, this invention relates to a game for two players who alternate turns. FIG. 1 illustrates an exemplary game board with 24 slots arranged as the borders of nine squares (or “zones”) 1-9, arranged in rows of 3×3. The slots comprise border slots 120c, 120b, 120a, etc. surrounding the entire group of nine zones. The interior slots, for example 120cb and 120bc, extend between adjacent zones. Each individual zone is surrounded by four border slots. For example, zone 3 is surrounded by border slots 120a, 120bb, 120abb and 120bba.

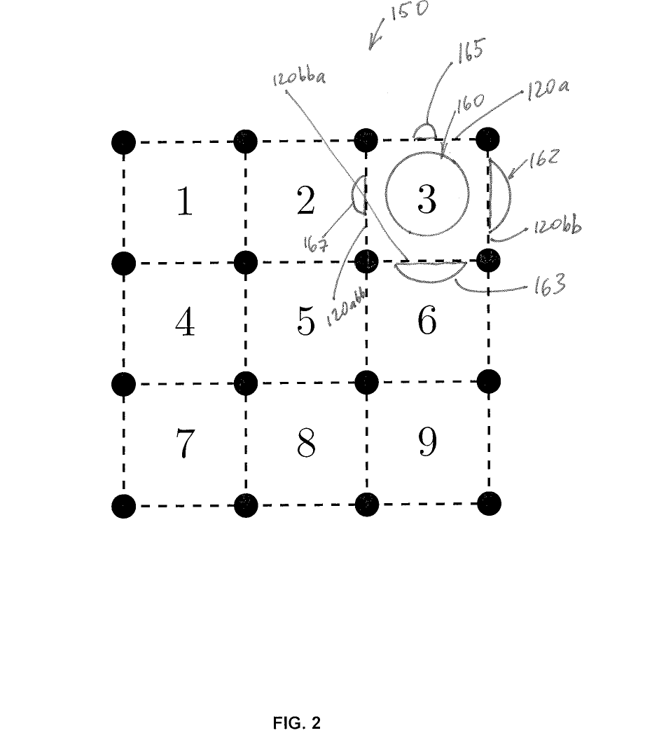

FIG. 2 illustrates the game board 150 similar to that shown in FIG. 1, with playing tokens, or coins, in play around zone 3. Playing tokens for different players may be distinguished in any number of ways. In one embodiment, tokens of players are distinguished according to the size of the token. In another embodiment, tokens may be distinguished according to a theme, such as color, shape, different animal pieces (e.g. giraffe pieces and elephant pieces), etc. In FIG. 1, two tokens of player 1 (165 and 167) are placed in vertical slots 120a and 120abb, respectively. Two larger tokens 162 and 163 are placed vertically within slots 120bb and 120bba, respectively. A player claiming the last border slot of a zone can claim the zone. For example, when player 2 has claimed the last border slot surrounding zone 3, player 2 can claim zone 3 by laying another token 160 on the surface within zone 3. Note that the horizontal orientation of the zone-claiming token 160 differs from the vertical orientation of the tokens in the border slots.

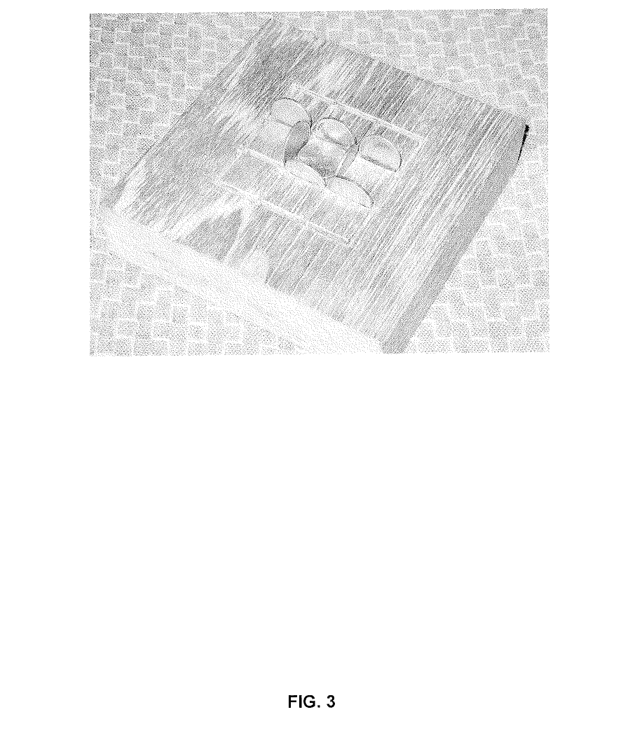

FIG. 3 is a photograph that illustrates actual positioning from an orthogonal view using coins as tokens in a grid similar to that of FIGS. 1 and 2. In one embodiment, the game may include the following rules:

Players alternate turns. A player must take her full turn, no part of the turn is optional. Players are never awarded an extra turn for any reason.

Each player has a collection of markers (e.g., coins or tokens) which are visually distinct from the other player's markers. For example, markers may differ in color, size, shape, or other attributes.

The exemplary board shown FIG. 1 includes of 24 line segments called slots (or border slots) which border the 9 square regions in a 3×3 array. In alternative embodiments, the game board may include any number of zones (e.g., square regions) in any dimension. For example, the game board may be include 16 regions in a 4×4 array or 18 regions in a 3×6 array. Players claim slots by placing their marker standing on end in the slot, and players claim squares by laying markers flat in the squares they are claiming. In one embodiment, the number of zones is odd so the two players cannot claim the same number of zones. Then, when no playable open slots are left and no other winning criteria are satisfied, the game may not result in a draw because one player has claimed more zones than the other player, thus determining a winner.

A player's turn consists of one or two parts:
A.) On every turn, the player to move places one of her markers in any single previously unselected slot.
B.) In addition, if the chosen slot borders a square for which the other three slots have already been claimed, then the player claims that square by laying one of her markers flat in the inside middle portion of the square.
C.) When a square is claimed it does not matter which players have claimed the first three slots around a square or in what order.
D.) In some cases, an empty slot simultaneously borders two squares for which all others slots have been claimed. In this case a player may claim two adjacent squares on a single turn.
E.) No extra turn is awarded for claiming a square.

Winning the game may occur according to any number of winning criteria.

In one embodiment, winning occurs when one of the three following winning criteria are satisfied:
A.) A player who claims all three slots along a line parallel to the slots wins immediately. For example, a player who claims three slots in a vertical line on the board wins. As one illustrative example, a player may win by claiming the slots labeled as 120a, 120b, and 120c in FIG. 1.
B.) A player who claims all three squares in a vertical, horizontal, or diagonal straight line, i.e. a Tic-Tac-Toe win, wins immediately. As illustrative examples, a player may win by claiming zones 1, 4, and 7 (vertical), zones 4, 5, and 6 (horizontal), or zones 1, 5, and 9 (diagonal) in FIG. 1. A player may win by claiming other vertical, horizontal, and diagonal zones in FIG. 1 as well.
C.) If the game ends with no winner by the two rules above, then the player having claimed the most squares wins.

Again, as noted previously, the number of total squares that comprise the game board may be more than nine as in typical Tic-Tac-Toe. For example, there may be a grid of four by four squares, totaling sixteen squares, or more. Furthermore, the squares may be arranged in other configurations such as a cross or a circular configuration with many more squares. Of course, in such alternate configurations, the number of and arrangement of a straight-line, claimed-square win such as this may differ. For example, on a 16-square square grid, a win would be four squares in a vertical, horizontal or diagonal straight line, etc. In other embodiments, the winning criteria may vary by the number of consecutive border slots or the number of claimed horizontal, vertical, or diagonal straight line regions. For example, in an embodiment with a 5×5 board, one exemplary winning criteria may be satisfied when a player claims any 4 consecutive slots in a parallel line. Or, in the 5×5 board, another exemplary winning criteria may be satisfied when a player claims any 3 consecutive horizontal, vertical, or diagonal square regions.

In the exemplary board shown in FIG. 1, there are 8 lines of 3 parallel slots on the board, but they are disjoint, every slot is in exactly one line. For this reason, winning by the first rule may be rare. Instead, a player forces the move of her opponent by claiming 2 slots in a line with the third empty.

According to the winning criteria described above, there are no ties or drawn games.

A second embodiment may be provided for 2 players, who alternate turns. The game is played on a larger board having 60 slots which are arranged as the borders of 25 squares arranged in 5 rows of 5.

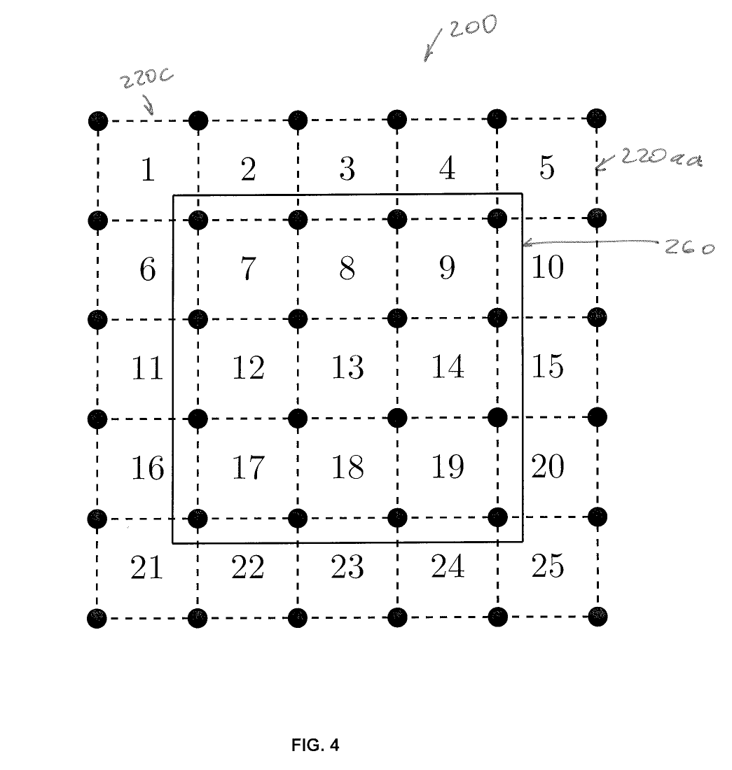

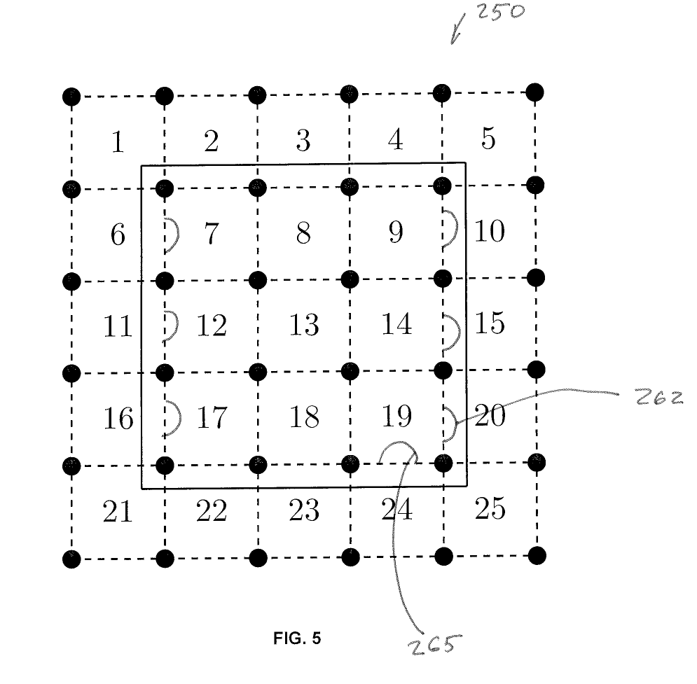

As shown in FIG. 4, the second embodiment comprising a larger playing board 200 includes 60 slot segments that border and define 25 individual square zones arranged in a 5×5 array and numbered 1-25. The nine zones in the center (numbers 7, 8, 9, 12, 13, 14, 17, 18 and 19) are surrounded by a distinguishing line 260 shown in FIG. 4. Gameplay may be similar to the first embodiment described above. As shown in FIG. 5, the filled game board 250 includes some tokens 262 and 265 oriented vertically in various slots.

Exemplary rules of play for the board shown in FIG. 4 may include the following:

The game may be played by 2 players.

Players may alternate turns. A player must take her full turn, no part of the turn is optional. Players are never awarded an extra turn for any reason.

Each player has a collection of markers (coins are used for the prototype) which are visually distinct from the other player's markers.

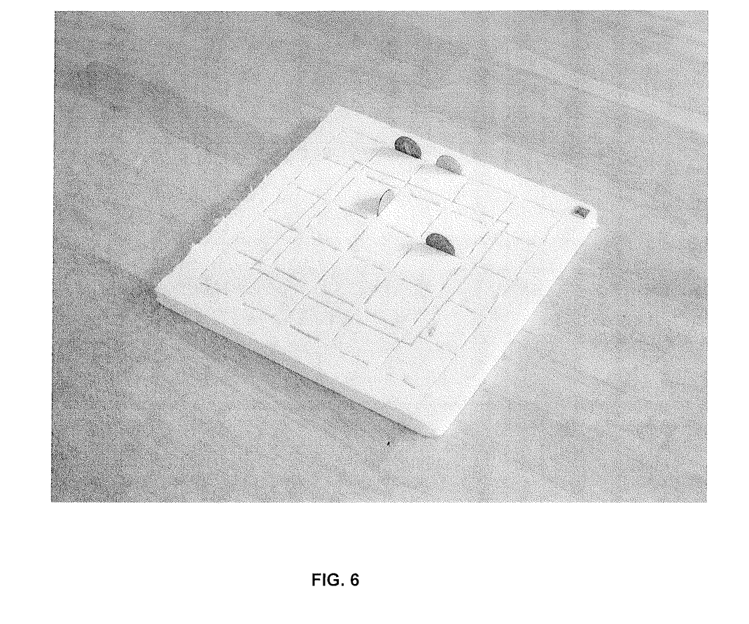

The photograph in FIG. 6 shows how a player claims a slot by placing their marker standing on end in the slot, and how a player claims a square by laying a marker flat in the claimed square.

A player's turn consists of one or two parts: claiming a slot and possibly claiming one or two squares.
A. On every turn, the player to move places one of her markers in a single previously unselected slot.
B. When a player claims a slot which borders a square for which the other three slots have already been claimed (i.e. the player completes a square), then in addition to the slot, the player also claims that square by laying one of her markers flat in the square.
C. When a square is claimed it does not matter which players have claimed the first three slots around a square or in what order.
D. In some cases, an empty slot simultaneously borders two squares for which all others slots have been claimed. In this case a player may claim two adjacent squares on a single turn.
E. No extra turn is awarded for claiming a square.
F. Play region restriction rule: All moves must occur within some region of the board consisting of the (24) slots bordering 9 squares in a square 3×3 region. That is, the first player chooses any slot, and on each subsequent move, the player to move must be able to identify a 3×3 region of squares which includes their move and all previously claimed slots and squares.

The playing region may be determined when a single unique 3×3 region is able to include all moves. The playing region may be determined on any of the first 17 moves.

The purpose of this rule is to weaken any advantage due to player order. This rule is optional and may be ignored by simple declaring the region of play to be the 9 central squares, which are highlighted on the board for this reason.

Winning may occur when one of any number of winning scenarios occur. For example, in FIG. 4, winning occurs when one of the following three winning scenarios occur:
A. A player who claims three consecutive slots along a line parallel to the slots wins immediately.
B. A player who claims all three squares in a vertical, horizontal, or diagonal straight line, i.e. a Tic-Tac-Toe win, wins immediately.
C. If the game ends with no winner by the two rules above, then the player having claimed the most squares wins.

Another General Specification of the Game

a) A game device may include a playing surface divided into a plurality of polygonal token locations called boxes which are bordered by slots. The game device may also include a plurality of labeled tokens for each player which may be easily distinguished from tokens labeled for other players. The tokens may be sized so that they may be both laid flat in any of the token locations and also placed vertically in any of slots so that a majority of the token is above the playing surface. A pre-determined collection of groups of slots may form one family of winning conditions called line-wins. A pre-determined collection of groups of boxes may form a second family of winning conditions called box-wins. A pre-determined collection of groups of boxes form a may third family of winning conditions called tie-breaks.

A pre-determined collection of groups of boxes and slots form a family of playing regions.

b) Play
i. Players alternate turns.
ii. A player's turn consists of claiming a single previously unchosen slot, and marking her choice by placing one of her tokens vertically in the slot. Depending on the layout of the playing surface and prior moves, the player may then claim some boxes.
iii. If player chooses the last unchosen slot bordering a box, she claims that box. This occurs regardless of which players had chosen other slots bordering that box.
iv. A slot may border a plurality of boxes, thus a player may claim a plurality of boxes on one turn.
v. Play region restriction rule: At all times, the player to move must be able to identify at least one of the playing regions which includes her move and all prior moves.

c) Winning:
i. A player wins immediately if she claims every slot in one of the line-wins.
ii. A player wins immediately if she claims every box in one of the box-wins.
iii. If all slots have been chosen and neither player has won by line-wins or box-wins, then a player who has claimed each box in one of the tie-breaks wins.

An Alternative Explanation of the Game

The symbol P(X) denotes the power set of the set X, i.e. the collection of all subsets of X.

a) The game makes use of six sets: S,L,B,W,T,R.
i. Set S of n slots S={1, 2, . . . , n}.
ii. Set L of line-wins. A line-win is a set of slots. L contained in P(S) is a subset of the set P(S) of subsets of slots.
iii. Set B of squares. A square is a set of slots. B contained in P(S) is a subset of the set P(S) of subsets of slots.
iv. Set W of square-wins. A square-win is a set of squares, so a square-win is a set of sets of lines.

W contained in P(B) is contained in P(P(S)).
v. Set T of tie-breaks. A tie-break is a set of squares. T contained in P(B) is contained in P(P(S)).
vi. Set R of playing-regions. A playing region is a set of slots. R is contained in P(S).

b) Play
i. Players alternate turns.
ii. A player's turn consists of claiming any single previously unchosen slot. Depending on the board, the player may then claim some squares.
iii. If player chooses the last unchosen slot of a square, she claims that square. This occurs regardless of which players had chosen other slots in that square.
iv. Note that in one embodiment of the game, it is possible for a player to claim two squares on the same turn. In more general embodiments of the game, depending on the set B, it may be the case that a player claims many squares on a turn.
v. Play region restriction rule: At all times, the player to move must be able to identify a playing region r of R which includes her move and all prior moves.

c) Winning:
i. A player who claims each slot in a line-win I of L wins immediately.
ii. A player who claims each square in a square-win w of W wins immediately.
iii. If all slots have been chosen and neither player has won by one of the rules above, then a player who has claimed each square in a tie-break t of T wins.

d) Note that there are endless choices for the sets S,L,B,W, and T, so in this sense, what has been described is a very large family of games.

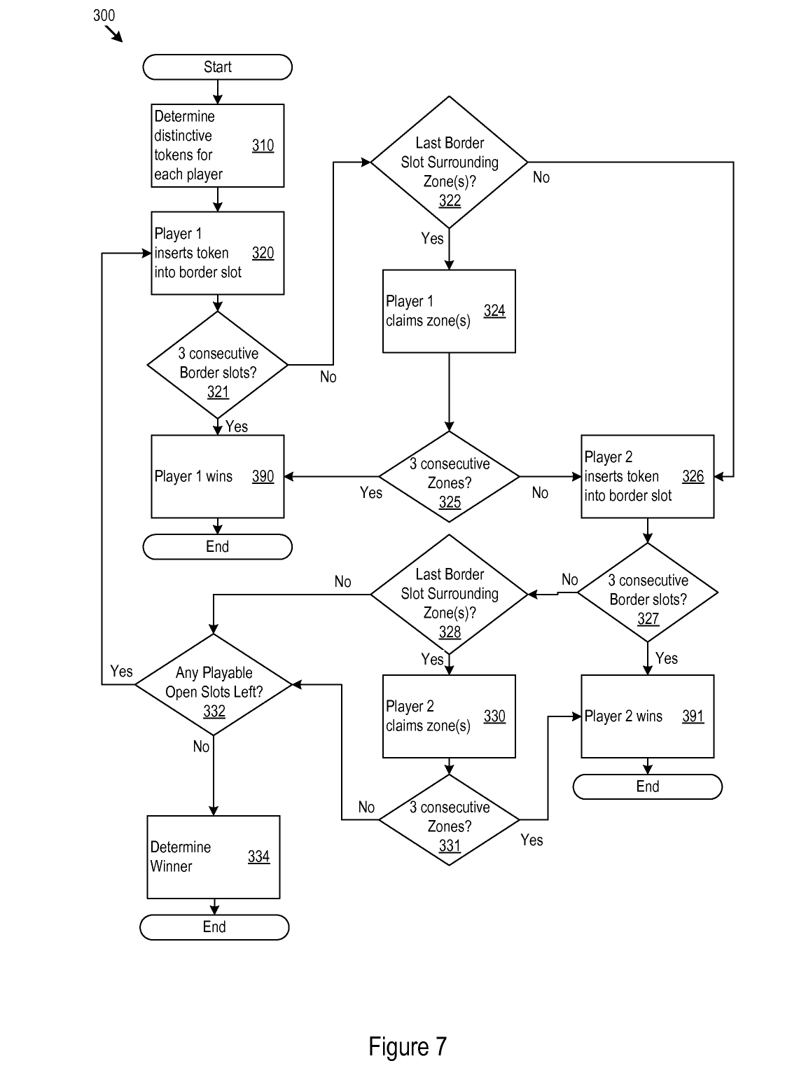

FIG. 7 shows a flow diagram 300 illustrating one embodiment of a method of play. In one embodiment, the flow diagram 300 may be implemented as game logic as part of an electronic device and displayed via a user interface.

As shown in the Figure, distinctive tokens are assigned to each player at 310. At 320, player 1 inserts a token into one of the border slots. In an electronic embodiment of the game, a device executing game logic described in FIG. 7 may receive a signal indicative of border slot selection by player 1. This signal may also, for example, generate an indicator on an electronic display that shows the players that the border slot has been claimed, such as shading in or coloring a corresponding section of border region or slot. At 321, it is determined if player 1 has satisfied a winning criteria of inserting tokens into three consecutive border slots in a vertical or horizontal line. If so, player 1 wins (390). If not, then it is determined if the border slot is the last slot surrounding a zone or multiple zones (322). If so, player 1 claims the zone or zones surrounded by the applicable chain of border slots at 324. At that point, a signal may be generated to indicate the claimed zone on a display at 324, wherein, for example, the entire claimed zone is shaded in a particular color or pattern on a display. Then, at 325, it is determined if player 1 has satisfied a winning criteria of claiming three consecutive horizontal, vertical, or diagonal zones (e.g., a tic-tac-toe win). If so, player 1 wins (390).

If not, player 2 can then insert a game token into another border slot at 326. In an electronic embodiment of the game, a device executing game logic described in FIG. 7 may receive a signal indicative of border slot selection by player 2. The procedures are carried out similarly to those illustrated in association with player 1 above. For example, at 327, it is determined if player 2 has satisfied a winning criteria of inserting tokens into three consecutive border slots in a vertical or horizontal line. If so, player 2 wins (391). If not, it is determined if the token is the last slot surrounding a zone or multiple zones (328). If so, then player 2 can claim the zone at 330 and he or she places a token on the zone or zones surrounded by the chain of border slots. Then, at 331, it is determined if player 2 has satisfied a winning criteria of claiming three consecutive horizontal, vertical, or diagonal zones (e.g., a tic-tac-toe win). If so, player 2 wins (391).

If there are any playable slots left (332), play turns to player 1 again. If there are no border slots left that are playable, then the winner may be determined at 334 by one or more of the methods described elsewhere herein. For example, the winner may be determined according to which player has claimed more total zones or claimed more tie-break zones. It should be emphasized that the gameplay method shown in the flow diagram is only an example in many respects, including how the game is completed and won. As described previously there are other ways the game may be completed such as prior to there being no further playable slots.

While preferred embodiments of the invention have been described, it should be understood that the invention is not so limited and modifications may be made without departing from the invention. For example, the embodiments described herein may be implemented as virtual representations on an electronic platform, such as on a computer, on the internet, or on a mobile device such as a phone or tablet device capable of simulating the gameplay described herein. These virtual representations may also be transmitted by email or by voice, and gameplay may be carried out by these means.

The methods and logic described above may be implemented in many different ways in many different combinations of hardware, software or both hardware and software. For example, the game may be electronically implemented in a system that may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above (e.g., game logic) may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

Furthermore, gameplay may also be carried out via less advanced means, such as through paper and pen, photographs, printing embodiments or other representations or implementations suitable for carrying out gameplay. Other 3-dimensional representations of gameboards and gameplay are also contemplated.

The scope of the invention is defined by the appended claims, and all devices and methods that come within the meaning of the claims, either literally or by equivalence, are intended to be embraced therein. Thus, it is intended that the foregoing detailed description be regarded as illustrative rather than limiting.

1. A method of playing a game between a plurality of players using a game board, said game board including a playing area divided into a plurality of zones by a plurality of border slots, each of said slots adapted to receive at least one game token therein, and said zones sized to receive at least one game token therein, said method comprising the steps of:
in repeating and alternating turns of each player, each player placing at least one game token in said at least one of said border slots, said at least one game token converting an open border slot into a closed border slot;
claiming one or more zones by placing at least one game token within one or more of said zones when one of said players converts the last open border slot to a closed border slot completely surrounding said one or more of said zones; and
determining a winner of said game by evaluating multiple winning criteria based any combination of a collection of groups of slots, a collection of groups of zones, or a number of zones claimed by each player.

2. The method of claim 1, wherein said step of determining a winner comprises evaluating a pre-determined collection of groups of slots.

3. The method of claim 1, wherein said step of determining a winner comprises evaluating a pre-determined collection of groups of zones.

4. The method of claim 1, wherein said step of determining a winner further comprises evaluating a pre-determined collection of groups of zones and slots.

5. The method of claim 1, wherein said step of determining a winner further comprises counting the number of claimed zones claimed by a respective player.

6. The method of claim 1, where the game token comprises a physical game token.

7. The method of claim 1, where the game board comprises an odd number of zones.

8. A game playing apparatus for use in playing a game using a plurality of game tokens, said board comprising:
at least one surface that may be marked with said game tokens;
a plurality of zones;
a plurality of slots bordering one or more zones, said slots configured to support at least one game token in a first orientation;
each of said one or more zones configured to support at least one game token in at least a second orientation, wherein for at least one zone, said slots define a border surrounding said zone; and
where the board is configured to allow game play between at least two players where the winner of said game play is determined by evaluating multiple winning criteria.

9. The game playing apparatus of claim 8, wherein for said at least one zone, said slots defining said border may each support one game token therein and at the same time said zone may support one game token therein.

10. The apparatus of claim 8, wherein said game tokens and said game board are physical objects.

11. The apparatus of claim 8, wherein said game tokens and said game board are electronic representations on a user interface screen of a computing device.

12. The apparatus of claim 8, where the multiple winning criteria includes when a player claims all slots along a line parallel to the slots.

13. The apparatus of claim 8, where the multiple winning criteria comprise when a player claims all zones in a vertical, horizontal, or diagonal straight line.

14. The apparatus of claim 8, where the multiple winning criteria comprise which player claims more zones when each of the plurality of slots is occupied by a game token and no other winning criteria are satisfied.

15. A method of playing a board game by opposing players, said game comprising:
a game board including a playing area divided into a plurality of zones, each zone bordered by a plurality of border slots;
at least two sets of distinguishable playing pieces, each set having movable pieces sized to fit both vertically within at least one of said border slots in one orientation and also within a single one of said zones in a second orientation;
placing each player's set of playing pieces, in alternating player turns, vertically and individually within said slots and when a first one of said opposing players places a playing piece in the last empty bordering slot of a first one of said zones:
said first one of said opposing players also placing a corresponding playing piece horizontally within said one of said first one of said zones to claim said first one of said zones;
said game board thereby including a first plurality of game pieces supported in a vertical position surrounding said first one of said zones and supporting a single game piece within said first one of said zones in said second orientation; and
determining a winner of said game by evaluating multiple winning criteria based any combination of a collection of groups of slots, a collection of groups of zones, or a number of zones claimed by each player.

16. The method of claim 15, wherein the second orientation is a horizontal orientation.

17. The method of claim 15, wherein said step of determining a winner comprises evaluating a pre-determined collection of groups of slots.

18. The method of claim 15, wherein said step of determining a winner comprises evaluating a pre-determined collection of groups of zones.

19. The method of claim 15, wherein said step of determining a winner further comprises evaluating a pre-determined collection of groups of zones and slots.

20. The method of claim 15, wherein said step of determining a winner further comprises counting the number of claimed zones claimed by a respective player.
